(19) United States
(12) Patent Application Publication
(10) Pub. No.: US 2012/0159423 A1
(43) Pub. Date: Jun. 21, 2012

(54) TENANT INDEPENDENT ADD-ON SOFTWARE PACKAGES FOR AN ENTERPRISE PLATFORM AS A SERVICE PRODUCT

(76) Inventors: Ralf Becker, Mannheim (DE); Thomas Schneider, Heidelberg (DE)

(21) Appl. No.: 12/971,821

(22) Filed: Dec. 17, 2010

(51) Int. Cl. G06F 9/44

(52) U.S. Cl. 717/102

(57) ABSTRACT

According to some embodiments, an add-on software package for an enterprise platform as a service product may be received from a partner. The add-on software package may be developed at a multi-tenant development system associated with the enterprise platform as a service product. The multi-tenant development system may, for example, store a plurality of development add-on software packages from a plurality of partners. An indication associated with the add-on software package and a first tenant may be received, and, responsive to the received indication, a development add-on software package may be switched on for the first tenant (and not switched on for a second tenant).

### FIELD

Some embodiments relate to a multi-tenant application platform. More specifically, some embodiments relate to the tenant independent add-on software packages for an enterprise platform as a service product.

### BACKGROUND

An application platform may execute applications (e.g., business enterprise processes) to provide business functions to a client. Efficiencies may be realized by providing functionality to multiple clients from a single application platform, which may be referred to as a “multi-tenant” application platform. Due to the sensitivity of business data, it may be preferable to isolate the data of each client (i.e., tenant) from the data of other tenants. More specifically, a tenant of a multi-tenant application platform may be unable to access the data of another tenant.

FIG. 1 is a generic block diagram of multi-tenant application platform 100. The elements of tenant A 110 are used to provide business functionality to a first customer, and the elements of tenant B 120 are used to provide business functionality to a second customer. In this regard, a tenant A database 114 includes data specific to the first customer, and a tenant B database 124 includes data specific to the second customer. Tenant A 110 is isolated from tenant B 120. More specifically, tenant A processes 112 are unable to access the tenant B database 124, and tenant B processes 122 are unable to access the tenant A database 114.

The multi-tenant application platform 100 may provide business solutions for small, medium, and/or large-sized companies. To provide appropriate business functionality for such a wide variety of groups, software packages called “add-ons” may be provided by independent software vendors, service centers, and/or the provider of the application platform 100. As used herein, the creators of add-on software packages are referred to as “partners” even if they are part of the organization that provides the application platform 100. The lifecycle management of the application platform 100 may be significant and may represent a relatively high share of the total cost of ownership of an information technology solution (e.g., lifecycle management of the application platform 100 may require highly skilled system administrators). Further, the development of add-on software packages is typically associated with a separate development system landscape (e.g., including a development system and/or an additional test systems for functional and performance testing).

The multi-function application platform 100 may offer services as Internet services and/or as an on demand service, such as a “platform as a service” product. In this case, typical ways of developing add-on software packages may not be sufficient to meet the requirements of a “cloud” development community. For example, it may be desirable to facilitate the development of add-on software packages without a dedicated system landscape for each partner and/or without highly skilled system administrators to provide a relatively low total cost of ownership for the application platform 100.

### BRIEF DESCRIPTION OF THE DRAWINGS

FIG. 1 is a block diagram of a multi-tenant application platform.

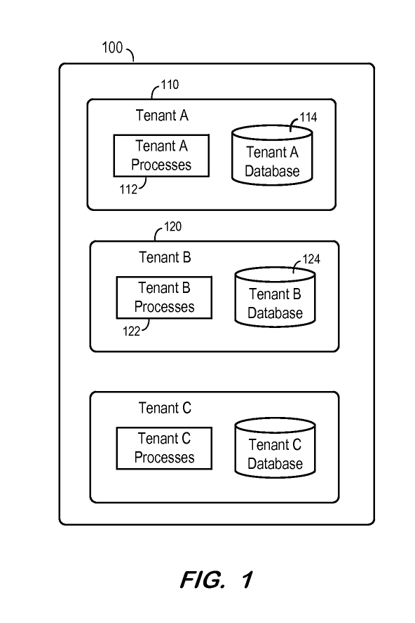

FIG. 2 is a block diagram of a system according to some embodiments.

FIG. 3 illustrates an add-on table and/or user interface in accordance with some embodiments.

FIG. 4 is a flow diagram of a process according to some embodiments.

FIG. 5 is a block diagram of a system landscape in accordance with some embodiments.

FIG. 6 is a block diagram of an add-on deployment system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

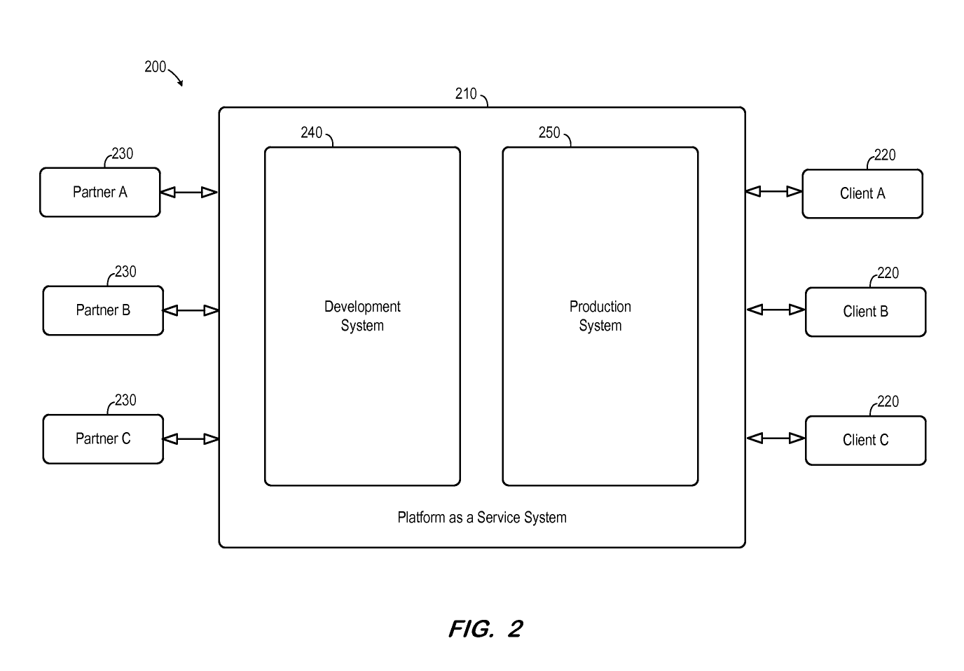

FIG. 2 is a block diagram of a system 200 according to some embodiments. Note that FIG. 2 represents a logical architecture for describing some embodiments, and actual implementations may include more or different components arranged in any manner. The system 200 may be implemented using any number of computer devices, and one or more processors of the system 200 may execute program code to perform processes described herein.

The system 200 includes a platform as a service system 210 that may provide business solutions for a number of clients 220 (e.g., clients A through C). Moreover a number of partners 230 (e.g., partners A through C) may develop add-on software packages to enhance the solutions that are available to the clients 220. As illustrated in FIG. 2, the platform as a service system 210 may include a development system 240 (e.g., used by the partners 230 when creating add-on software packages) and/or a production system 250 (e.g., accessed by clients 220 during normal business operations). According to some embodiments, the development system 240 and/or production system 250 may comprise multi-tenant platforms (e.g., different tenants may be associated with different clients 220 and/or partners).

Moreover, according to some embodiments the software packages associated with the enterprise platform as a service system 210 may be tenant independent. For example, a partner 230 may create add-on software packages via a Software Development Kit (“SDK”) against a development tenant in the development system 240 which is shared by other partners 230. The add-on software package may be registered centrally in the production system 250 and stored in a central service market place (e.g., an application store). The add-on software package may also be deployed to test tenant in a test system (not illustrated in FIG. 2) that is shared by multiple partners 230. Finally, the add-on software package may be deployed to a customer production tenant in the production system 250 that is shared by other customers 220. According to some embodiments, a partner might be blocked from accessing applications associated with other partners.

Note that the add-on software package deployment process may be associated with, for example, an initial customer implementation or an existing implementation (e.g., as a “change project”). Note that the deployment process may be associated with a merge of add-on content and application platform content that as appropriate to meet the business expectations of the customer. According to some embodiments, an add-on software package may be un-deployed from a customer production tenant after a trial phase (e.g., add-on software package is returned by the customer). According to some embodiments, an add-on software package may represent a change or patch to a prior add-one software package. For example, patched content may deployed on the system 200 and on the tenants in which the add-on software package is registered (and the patched add-on content may be merged with the remaining add-on content and the application platform content). In some cases, an add-on software package may be associated with an upgrade to a new version of the package (e.g., when a partner 230 develops new functions and/or features).

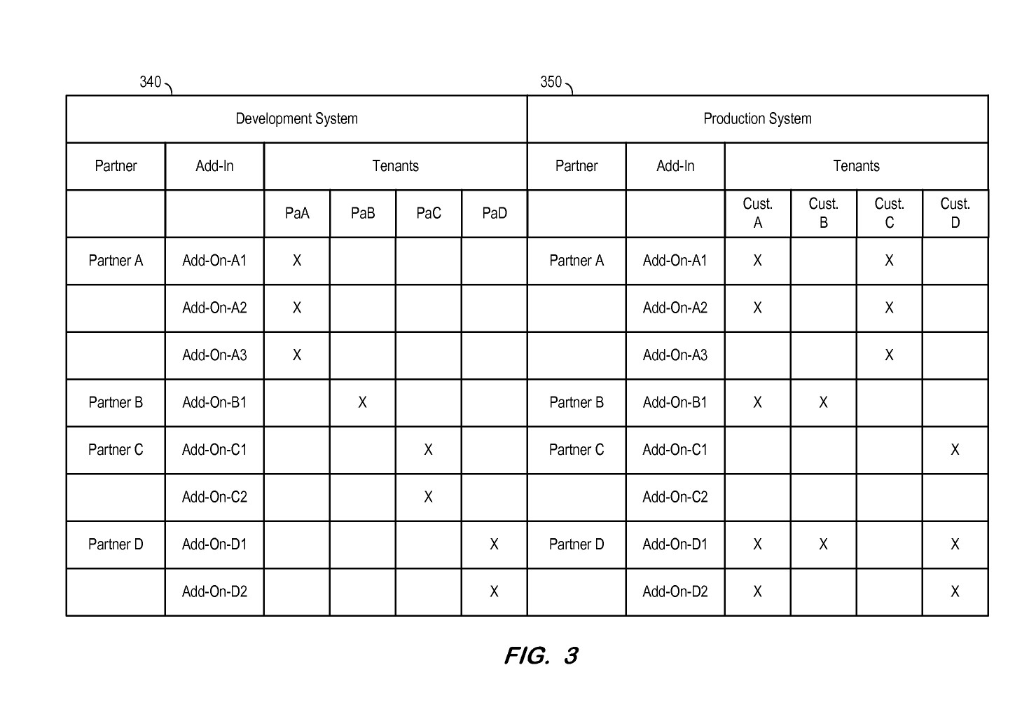

According to some embodiments, an add-on software package may be switched on (e.g., become available to and/or accessible by) with respect to partner A without being switched on with respect to partner B. Similarly, an add-on software package may be switched on with respect to client A without being switched on with respect to client B. For example, FIG. 3 illustrates an add-on table and/or User Interface (UI) in accordance with some embodiments. In particular, a development system portion 340 controls which add-on software packages are switched on for which partners. As illustrated in FIG. 3, for example, “Add-On-C1” and “Add-On-C2” are switched on for partner C but not for partners A, B, or D. Similarly, a production system portion 350 controls which add-on software packages are switched on for which clients or customers. As illustrated in FIG. 3, for example, “Add-On-B1” from partner B is switched on for customers A and B but not for customers C or D.

Thus, embodiments may support multi-tenancy and/or multiple add-on abilities on a single system (e.g., add-on software packages may be tenant-independent, and be switched on tenant by tenant).

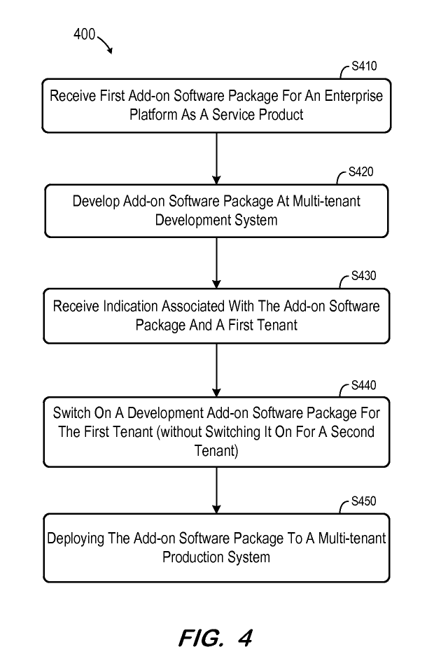

FIG. 4 is a flow chart of a process 400 that may be performed in connection with, for example, the platform as a service system 210 of FIG. 2 according to some embodiments. The flow charts described herein do not necessarily imply a fixed order to the actions, and embodiments may be performed in any order that is practicable. Note that any of the methods described herein may be performed by hardware, software (including low level language code), firmware, or any combination of these approaches. For example, a storage medium may store thereon instructions that when executed by a machine result in performance according to any of the embodiments described herein.

At S410, an add-on software package for an enterprise platform as a service product may be received from a partner. The add-on software package may have been created, for example, with a SDK and may be associated with: (i) an initial installation of the enterprise platform as a service product, (ii) a change to the enterprise platform as a service product, and/or (iii) a change to a prior add-on software package.

At S420, the add-on software package may be deployed to and developed at a multi-tenant development system. The multi-tenant development system may be, for example, associated with the enterprise platform as a service product and may store a plurality of development add-on software packages from a plurality of partners. According to some embodiments, the plurality of add-on software packages are stored in a central repository of the development system.

An indication associated with the add-on software package and a first tenant may be received at S430. For example, the indication might be retrieved from a table or received from an administrator via a UI. At S440, responsive to the received indication, a development add-on software package may be switched on for the first tenant (and not be switched on for a second tenant).

At S450, the add-on software package may be deployed to a multi-tenant production system associated with the enterprise platform as a service product, wherein the multi-tenant production system stores a plurality of production add-on software packages from a plurality of partners. Moreover, an indication associated with the add-on software package and the first customer tenant may be received, and, responsive to the received indication, the production add-on software package may be switched on for the first customer tenant (without being switched on for the second customer tenant). In this way, tenant independent add-on software packages may be provided in connection with multiple partners and/or customers. According to some embodiments, the add-on software package may also be removed or “un-deployed” from the development and/or the production systems.

According to some embodiments, the add-on software package may be stored as a source artifact, and a compiler may generate a generated artifact from the source artifact based on a scope of a customer selected in a business configuration work center. For example, source artifacts may belong to partners and a platform provider might avoid changing source artifacts (e.g. during an upgrade). Generated artifacts, however, may be changed by the platform provider (e.g. during an upgrade). Thus, an add-on software package may be associated with both a business content relevant solution and a “main” solution. The business content relevant part may be, for example, activated first in a customer tenant, and subsequently the customer perform a scope definition and/or configuration of the add-on software package. After finishing the definition and/or configuration, a final generated artifact may become visible in the customer system.

According to some embodiments, the process 400 of FIG. 4 may be associated with a collection of Application Programming Interfaces (“APIs”) on a partner development backend which may be called by a partner frontend tool to handle and/or maintain the lifecycle status of a partner development project, to make the calls to Add-on Assembly Kit (“AAK”) and/or other tools in the backend, to trigger a test deployment of an add-ons software packages, and/or to trigger a release of the add-ons software package to a service market place. Note that add-on software packages may, according to some embodiments, be associated with any programming language, such as Advanced Business Application Programming (“ABAP”), Java, or C content.

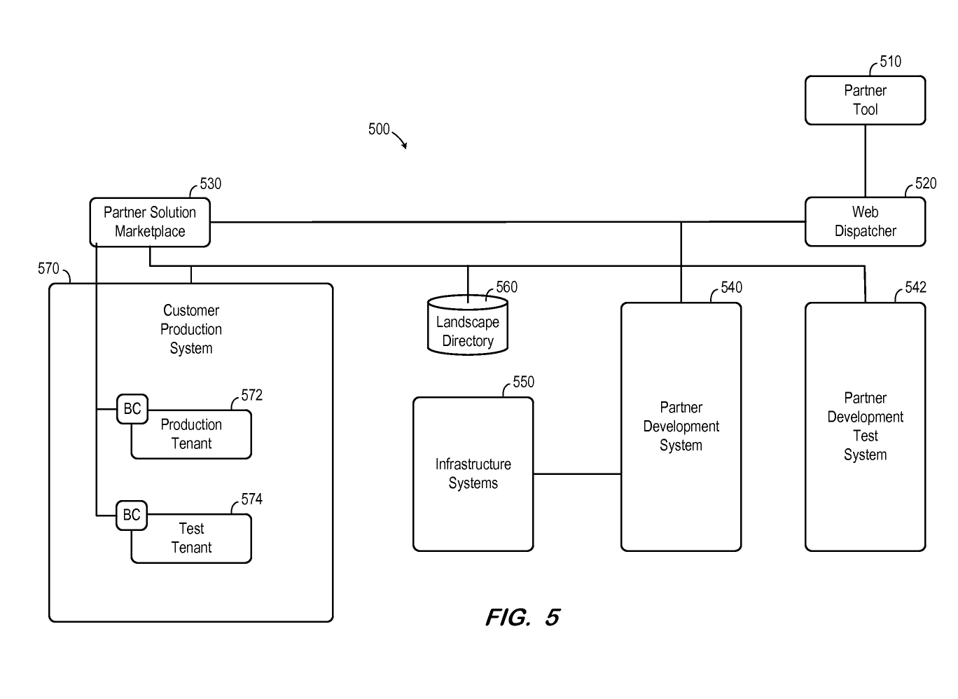

FIG. 5 is a block diagram of a system landscape 500 in accordance with some embodiments. A partner tool 510 may facilitate development of an add-on software package via a SDK against the development tenant. The partner tool 510 may communicate with platform as a service provider, for example, via a web dispatcher 520 using a browser and HyperText Transfer Protocol (“HTTP”) requests and responses. The partner tool 510 may also be associated with, for example, a key user tool (e.g., an Excel® add-in for analytics), Microsoft .Net, a Microsoft® Visual Studio plug-in or isolated shell, Adobe® LifeCycle Designer, and/or Crystal® Reports Designer.

Generally, the partner tool 510 and web dispatcher 520 may communicate via any internal or external network, networks, sub-network, or combination thereof operable to facilitate communications between various computing components inside and outside the illustrated landscape 500. The partner tool 510 and web dispatcher 520 may communicate, for example, Internet Protocol (“IP”) packets, Frame Relay frames, Asynchronous Transfer Mode (“ATM”) cells, voice, video, data, and other suitable information between network addresses. The landscape 500 may also include one or more Local Area Networks (“LANs”), Radio Access Networks (“RANs”), Metropolitan Area Networks (“MANs”), Wide Area Networks (“WANs”), all or a portion of the Internet, and/or any other communication system or systems at one or more locations.

Note that any of the devices illustrated in FIG. 5 may be associated with one or more processors. Moreover, each processor may be a Central Processing Unit (“CPU”), a blade, an Application Specific Integrated Circuit (“ASIC”), a Field-Programmable Gate Array (“FPGA”), or another suitable component. Generally, the processors may execute software instructions and manipulates data to perform any of the operations and embodiments described herein. Regardless of the particular implementation, software may include computer-readable instructions, firmware, wired or programmed hardware, or any combination thereof on a tangible medium, as appropriate. Indeed, each software component may be fully or partially written or described in any appropriate computer language including C, C++, Java, Visual Basic, assembler, Perl, as well as others, including languages and operating systems designed specifically for a platform as a service system. It will be understood that while portions of the landscape 500 illustrated in FIG. 5 are shown as individual modules or blocks that implement the various features and functionality through various objects, methods, or other processes, the landscape 500 may instead include a number of sub-modules or blocks, third-party services, components, libraries, and such, as appropriate. Conversely, the features and functionality of various components can be combined into single components, as appropriate.

The web dispatcher 520 may facilitate an exchange of information between the partner tool 510 and a partner development system 540 and partner development test system 542. The partner development system 540 may, for example be associated with a development tenant and an AAK engine and may access infrastructure systems 550, such as a Service Market Place (“SMP”) and/or Product and Production Management System (“PPMS”) databases. The partner development test system 542 may host a deployment test tenant and associated business content. According to some embodiments, a landscape directory 560 may store a central Service Provider Cockpit (“SPC”) and registry. A partner solution marketplace 530 may also be coupled to a customer production system 570 having a production tenant 572 and a test tenant 574 (each associated with business content). Note that the production tenant 572 and the test tenant 574 might be provided on different systems. According to some embodiments, content may be registered in PPMS of the landscape directory 560 and assembled and shipped to the SMP of the infrastructure systems 550. The content may then be deployed to the test tenant in the partner development test system 542 (and registered on the appropriate system and tenant) and the final content may be deployed to customer tenants in the customer production system 570.

According to some embodiments, each partner developing add-on software packages may access: (1) a development system, (2) a deployment test system, (3) a maintenance system, and (4) maintenance test system. That is, one tenant may be provided for each partner on each of these four systems (e.g., representing a “tenant quadruple”). Note that partners might develop, maintain and tests several add-ons in one tenant quadruple. Moreover, multiple partners may work with multiple add-on software packages on one system, and the add-ons are tenant-independent (switched on by tenant).

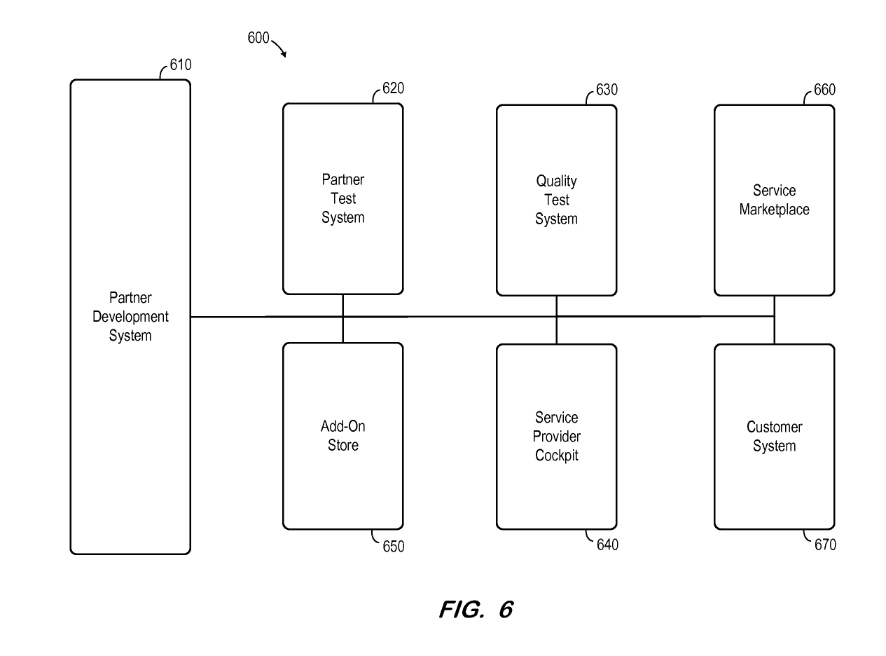

FIG. 6 is a block diagram of an add-on deployment system 600 according to some embodiments. In particular, the deployment system may include a partner development system 610. The partner development system 610 may, for example, be used to create a solution (e.g., an add-on software package), develop and test the solution, trigger a test deployment of the solution, request a quality review of the solution, and/or to create a patch.

The deployment system 600 may further include a partner test system 620 and/or a quality test system 630 (e.g., to deploy and test potential solutions). A service provider cockpit 640 may receive test results from the quality test system 640, register an ad-on for installation, and/or trigger a system activation when a customer purchases an item in an add-on store 650. According to some embodiments, the add-on store 650 may list an add-on software package when it has been approved by the quality test system 630.

A service marketplace 660 may upload an add-on software package when it is received from the partner development system 610. Finally, a customer system 670 may deploy the add-on software package (after it is received from the service market place 660) and activate in business configuration as appropriate.

When a partner project is created, the following information might be provided and/or registered by the system 600: an ABAP namespace, and HTTP namespace for external communications (e.g., via web services) and potentially a unique namespace for internal content separations (e.g., of the generated artifacts), a product version (e.g., to be registered centrally in the PPMS), and a transport request number. Moreover, a partner add-on software package may consist of one software component containing a structure package, a package that contains transported “main” content, and a package that contains transported partner resource files from which BC content in a target system may be generated. According to some embodiments, there may be multiple software components when multiple projects are supported.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the applications and databases described herein may be combined or stored in separate systems). Similarly, although a particular information flow and user interactions have been given as examples, other and/or additional steps may be performed in accordance with any embodiments described herein.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method implemented by a computing system in response to execution of program code by a processor of the computing system, the method comprising:
receiving, from a partner, an add-on software package for an enterprise platform as a service product;
developing the add-on software package at a multi-tenant development system associated with the enterprise platform as a service product, wherein the multi-tenant development system stores a plurality of development add-on software packages from a plurality of partners;
receiving an indication associated with the add-on software package and a first tenant; and
responsive to the received indication, switching on a development add-on software package for the first tenant, wherein the development add-on software package is not switched on for a second tenant.

2. The method of claim 1, wherein the plurality of add-on software packages are stored in a central repository of the development system.

3. The method of claim 2, further comprising:
deploying the add-on software package to a multi-tenant production system associated with the enterprise platform as a service product, wherein the multi-tenant production system stores a plurality of production add-on software packages from a plurality of partners;
receiving an indication associated with the add-on software package and a first customer tenant; and
responsive to the received indication, switching on the production add-on software package for the first customer tenant, wherein the production add-on software package is not switched on for a second customer tenant.

4. The method of claim 3, further comprising:
un-deploying the add-on software package from the development and production systems.

5. The method of claim 2, wherein the add-on software package is stored as a source artifact.

6. The method of claim 5, further comprising:
generating, by a compiler, a generated artifact from the source artifact based on a scope of a customer selected in a business configuration work center.

7. The method of claim 1, wherein the add-on software package was created with a software development kit.

8. The method of claim 1, wherein the add-on software package comprises a part of an initial installation of the enterprise platform as a service product.

9. The method of claim 1, wherein the add-on software package comprises a change to the enterprise platform as a service product.

10. The method of claim 1, wherein the add-on software package comprises a change to a prior add-on software package.

11. The method of claim 1, wherein the add-on software package is associated with both: (i) a generation of business configuration content, and (ii) main content.

12. A non-transitory medium having program code stored thereon, the program code executable by a processor to:
receive, from a partner, an add-on software package for an enterprise platform as a service product;
developing the add-on software package at a multi-tenant development system associated with the enterprise platform as a service product, wherein the multi-tenant development system stores a plurality of development add-on software packages from a plurality of partners;
receive an indication associated with the add-on software package and a first tenant; and
responsive to the received indication, switch on a development add-on software package for the first tenant, wherein the development add-on software package is not switched on for a second tenant.

13. The medium of claim 12, wherein the plurality of add-on software packages are stored in a central repository of the development system.

14. The medium of claim 13, further storing program code executable by the processor to:
deploy the add-on software package to a multi-tenant production system associated with the enterprise platform as a service product, wherein the multi-tenant production system stores a plurality of production add-on software packages from a plurality of partners;
receive an indication associated with the add-on software package and a first customer tenant; and
responsive to the received indication, switch on the production add-on software package for the first customer tenant, wherein the production add-on software package is not switched on for a second customer tenant.

15. The medium of claim 14, further storing program code executable by the processor to:
un-deploy the add-on software package from the development and production systems.

16. The medium of claim 13, wherein the add-on software package is stored as a source artifact.

17. The medium of claim 16, further storing program code executable by the processor to:
generate, by a compiler, a generated artifact from the source artifact based on a scope of a customer selected in a business configuration work center.

18. The medium of claim 16, wherein the add-on software package comprises at least one of: (i) a part of an initial installation of the enterprise platform as a service product, (ii) a change to the enterprise platform as a service product, or (iii) a change to a prior add-on software package.

19. A computer-implemented system, comprising:
a communication port to receive, from a partner, an add-on software package for an enterprise platform as a service product;
a multi-tenant development system storing a plurality of development add-on software packages from a plurality of partners; and
a development system to receive an indication associated with the add-on software package and a first tenant, and, responsive to the received indication, switch on the development add-on software package for the first tenant, wherein the development add-on software package is not switched on for a second tenant.

20. The system of claim 19, further comprising:
a production system to receive an indication associated with the add-on software package and the a first customer tenant, and, responsive to the received indication, switch on the production add-on software package for a first customer tenant, wherein the production add-on software package is not switched on for a second customer tenant.

21. The system of claim 19, wherein the add-on software package comprises at least one of: (i) a part of an initial installation of the enterprise platform as a service product, (ii) a change to the enterprise platform as a service product, or (iii) a change to a prior add-on software package.
